(19) United States
(12) Patent Application Publication
(10) Pub. No.: US 2025/0113000 A1
(43) Pub. Date: Apr. 3, 2025

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: TOMOYA SATO, Kanagawa (JP)

(21) Appl. No.: 18/892,619

(22) Filed: Sep. 23, 2024

(30) Foreign Application Priority Data
Sep. 28, 2023 (JP) 2023-166795

(51) Int. Cl. H04N 1/00; G06F 16/957; G06F 21/32

(52) U.S. Cl. CPC H04N 1/00464; G06F 16/9577; G06F 21/32

(57) ABSTRACT

An information processing apparatus is an information processing apparatus communicable with a client terminal that can use a web browser, including: a reception unit that receives request information including request setting information set to the web browser; an authentication unit that performs authentication processing of a user who uses the information processing apparatus via the web browser in a case where the request information is received by the reception unit; and a changing unit that changes personal setting information associated with the user based on the request setting information in a case where the authentication processing of the user by the authentication unit succeeds, and the personal setting information and the request setting information are different from each other.

### BACKGROUND OF THE INVENTION

### Field of the Invention

The present disclosure relates to an information processing apparatus, a method of controlling the information processing apparatus, and a storage medium.

### Description of the Related Art

An image formation apparatus having a function of a web server is known as one of information processing apparatuses. This information processing apparatus establishes communication with a web browser operating on a client terminal according to an HTTP protocol. Specifically, this information processing apparatus has a function of executing a job and the like of the image formation apparatus according to an HTTP request as the image formation apparatus and a function of responding a web page to the client terminal as an HTTP response. These functions are called a remote UI function. Regarding the image formation apparatus having the remote UI function, Japanese Patent Laid-Open No. 2004-213462 discloses a technique of determining a language to be displayed on a web page based on prioritized language information (referred to as PTL 1).

In the technique disclosed in PTL 1, in a case where a language included in an Accept-Language header is not supported, the web page is responded in a language used in an operation panel of the image formation apparatus. However, in some cases, the language used in the operation panel of the image formation apparatus is a language that is not recommended for a user browsing the web browser. If the user operates the image formation apparatus from the web page by the remote UI function in this case, it is assumed that the user performs the operation by using the language that is displayed on the operation panel of the image formation apparatus but is not recommended for the user browsing the web browser. Therefore, there is a possibility that the convenience for the user is reduced.

### SUMMARY OF THE INVENTION

An information processing apparatus according to an aspect of the present disclosure is an information processing apparatus communicable with a client terminal that can use a web browser, including: a memory; and a processor connected to the memory, in which the processor receives request information including request setting information set to the web browser, performs authentication processing of a user who uses the information processing apparatus via the web browser in a case where the request information is received by the receiving, and changes personal setting information associated with the user based on the request setting information in a case where the authentication processing of the user by performing the authentication processing succeeds, and the personal setting information and the request setting information are different from each other.

Further features of the present invention will become apparent from the following description of exemplary embodiments with reference to the attached drawings.

### BRIEF DESCRIPTION OF THE DRAWINGS

FIG. 1 is a diagram illustrating an example of a system configuration;

FIG. 2 is a diagram illustrating an example of a hardware configuration of an image formation apparatus;

FIG. 3 is a diagram illustrating an example of software configurations of the image formation apparatus and a PC;

FIG. 4 is a diagram schematically illustrating an example of a configuration of personal setting data;

FIG. 5 is a flowchart describing cooperation processing between a web browser and the image formation apparatus;

FIG. 6 is a diagram illustrating an example of an authentication screen displayed by the web browser;

FIG. 7 is a diagram illustrating an example of an authentication error screen displayed by the web browser;

FIG. 8 is a diagram illustrating an example of a remote UI screen displayed by the web browser;

FIG. 9 is a diagram illustrating an example of a login screen displayed on a display and operation unit;

FIGS. 10A and 10B are diagrams illustrating an example of a home screen displayed on the display and operation unit;

FIG. 11 is a flowchart describing cooperation processing between the web browser and the image formation apparatus;

FIG. 12 is a diagram illustrating an example of the remote UI screen displayed by the web browser;

FIG. 13 is a diagram schematically illustrating an example of a configuration of the personal setting data;

FIG. 14 is a diagram illustrating an example of a screen after login that is displayed on the display and operation unit;

FIG. 15 is a flowchart describing cooperation processing between the web browser and the image formation apparatus; and

FIG. 16 is a diagram illustrating an example of the remote UI screen displayed by the web browser.

### DESCRIPTION OF THE EMBODIMENTS

Hereinafter, preferred embodiments of the present disclosure will be described in detail in reference to the accompanying drawings. The following embodiments are not intended to limit the matters disclosed herein. In addition, all the combinations of features described in the following embodiments are not necessarily essential for the solution of the present disclosure. Herein, the same constituent elements will be designated with the same reference sign.

### First Embodiment

### <System Configuration>

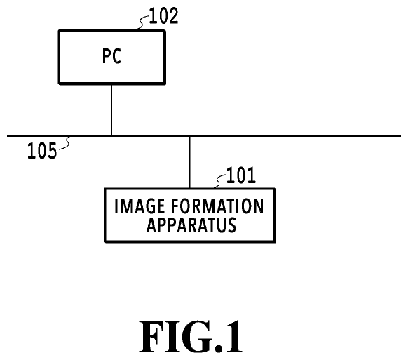

FIG. 1 is a diagram illustrating an example of a system configuration. This system includes an image formation apparatus 101 and a personal computer 102 (also referred to as a PC 102). The image formation apparatus (an image processing apparatus) 101 and the PC 102 are connected to each other via a local area network (LAN) 105. The image formation apparatus 101 has a function of a web server as a server (also referred to as an information processing apparatus). The PC 102 has a function of a web browser as a client terminal. The image formation apparatus 101 has a function of a remote UI that enables a remote operation from the PC 102 via a web page displayed on the PC 102 after the communication with the PC 102 is established.

Specifically, in a case where an HTTP request (also referred to as request information) arrives from the PC 102 after the communication with the PC 102 is established, the image formation apparatus 101 responds a resource of a website formed of at least one web page to the PC 102. As the client terminal, the PC 102 transmits the HTTP request to the image formation apparatus 101 via the web browser being executed. In the present embodiment, although an example in which the PC 102 is connected to the image formation apparatus 101 as one of client terminals is described, the client terminal connected to the image formation apparatus 101 is not limited to the PC 102. Any client terminal may be applicable as long as it has the function of the web browser. The client terminal may be a mobile terminal having the function of the web browser that is, for example, a smartphone. Alternatively, the client terminal may be another image formation apparatus having the function of the web browser.

Note that, although FIG. 1 illustrates an example in which the LAN 105 is a wired LAN, the LAN 105 may be a wireless LAN in a case where the image formation apparatus 101 and the PC 102 each have a function of wireless communication. In the descriptions below, the image formation apparatus 101 having the function of the web server is referred to as a server as needed. Additionally, the client terminal connected to this server is referred to as a client as needed.

### <Overview of Remote UI Function>

The function of the remote user interface (UI) implemented after the PC 102 is connected to the image formation apparatus 101 is described. In a case where there is a request of the HTTP request from the web browser of the client, the image formation apparatus 101 executes processing based on a uniform resource identifier (URI) included in the HTTP request. Specifically, the image formation apparatus 101 refers to the URI in a request row of the HTTP request and also refers to “Accept-Language” and the like in a header of the HTTP request. In this case, the URI is a collective term of an identifier to recognize the resource (a file or a directory) on the web. The URI is formed of a uniform resource locator (URL) and a uniform resource name (URN). The URL is an identifier to specify a place of the resource on the web. The URN is an identifier to uniquely identify the resource on the web.

The image formation apparatus 101 creates an HTTP response with reference to contents of the HTTP request as described above. A body of the HTTP response includes web page data described by a hyper text markup language (HTML), a script language, and the like. The image formation apparatus 101 transmits the above-described HTTP response to the client. Once the web browser of the client receives the HTTP response, the web browser of the client forms a screen based on the web page data included in the HTTP response and displays the formed screen. Thus, the communication between the image formation apparatus 101 and the web browser of the client is established according to the HTTP protocol. Therefore, the image formation apparatus 101 allows the client to use the function of the remote UI such as confirming a current state of the image formation apparatus 101, performing various types of setting, and confirming a processing state of a printing job or performing an operation. That is, the client can use the function of the remote UI of the image formation apparatus 101. The function of the remote UI as described above is used via the web browser. Note that, details of the HTTP request are described later.

In this case, the current state of the image formation apparatus 101 includes, for example, an operation state of the image formation apparatus 101, paper feeding information, and an ink remaining amount. The operation state of the image formation apparatus 101 includes at least any one of a normal state, a state in which an alert is issued, and a state in which an error occurs and printing is unavailable. The paper feeding information is information indicating a size and a type of a printing medium set in a paper feeding unit of the image formation apparatus 101 and a printing medium remaining amount. Note that, in a case where the PC 102 is connected to the image formation apparatus 101, a communication path is established by a TCP protocol as a previous step of the communication established by the HTTP protocol. In establishing this communication path, a TCP port number that allows for transmission and reception may be designated, and the PC 102 may be remotely connected to the image formation apparatus 101 by virtual network computing (VNC), for example.

### <Hardware Configuration>

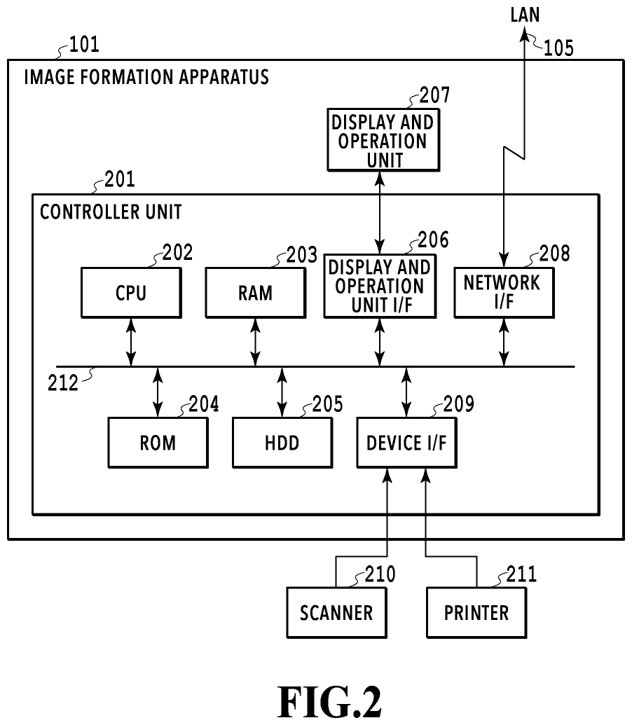

FIG. 2 is a diagram illustrating an example of a hardware configuration of the image formation apparatus 101. The image formation apparatus 101 includes a controller unit 201 and a display and operation unit 207. The display and operation unit 207 has a configuration to receive an operation by the user and to display various contents. Specifically, the display and operation unit 207 includes a display screen that displays the various contents and a hard key that receives the operation by the user. The display screen is a liquid crystal display, for example; however, it is not particularly limited thereto. The display screen may be an organic electro luminescence (EL) display. Alternatively, the display screen may be a light emitting diode (LED) display. The device that receives the operation by the user may be a touch panel instead of the hard key. Alternatively, the device that receives the operation by the user may be both the hard key and touch panel. In this case, a configuration that allows for use of the combination of the hard key and the touch panel by arranging the hard key and the touch panel adjacent to each other may be applied. The touch panel may be formed as a display including a touch panel by putting the touch panel on a display in a thickness direction of various displays such as a liquid crystal display, for example.

Note that, the image formation apparatus 101 is a printing apparatus (a printer), for example. The printing apparatus indicates an apparatus that includes a printing device having a printing function to print information on the printing medium by using a printing material. Additionally, for example, the image formation apparatus 101 may be an apparatus additionally including a reading device that reads an image on a document and functioning as a copier or may be a multi-function peripheral (MFP) to which another function is added. In addition, for example, various devices such as a personal computer (PC), a smartphone, and a digital camera may be applied as the image formation apparatus 101 of the present embodiment.

The controller unit 201 includes a central processing unit (CPU) 202, a random access memory (RAM) 203, and a read only memory (ROM) 204. The controller unit 201 includes a system bus 212 and a hard disc drive (HDD) 205. The controller unit 201 includes a display and operation unit I/F 206, a network I/F 208, and a device I/F 209.

The CPU 202 is a computation device that controls overall the image formation apparatus 101. The CPU 202 performs various types of control via the system bus 212. The ROM 204 is a non-volatile memory. The ROM 204 stores image data, other data, various programs for the operation by the CPU 202, and the like. The RAM 203 is a volatile memory. The RAM 203 is used as a temporary storage region such as a main memory and a working area of the CPU 202. In operating the image formation apparatus 101, a program such as an operating system, system software, and application software and various data referenced in executing each program are deployed from the ROM 204 to the RAM 203 as needed.

That is, the CPU 202 controls each unit of the image formation apparatus 101 by deploying the program stored in the ROM 204 to the RAM 203 to execute. Note that, the program for the operation by the CPU 202 is not limited to that stored in the ROM 204, and a program stored in advance in the HDD 205 may be used. The HDD 205 stores the program such as the operating system, the system software, and the application software and the various data referenced in executing each program such as image data and setting data. However, another storage device such as an SSD, an SD memory card, or an embedded Multi Media Card (eMMC) may be used as long as it can store data. Alternatively, the CPU 202 may import data stored in a detachable semiconductor memory via a not-illustrated interface unit and deploy the data to the RAM 203 to execute.

The display and operation unit I/F 206 is an interface for the display and operation unit 207. The display and operation unit I/F 206 outputs information to be displayed on the display and operation unit 207 to the display and operation unit 207. Alternatively, the display and operation unit I/F 206 receives information inputted to the display and operation unit 207 by the user. The network I/F 208 is an interface for the LAN 105. The network I/F 208 is connected to the LAN 105 and establishes communication with the PC 102 and the like connected on the same LAN. The device I/F 209 is an interface for various devices. The various devices are a scanner 210 and a printer 211. The scanner 210 has a function of obtaining the image printed on the document as the image data by a scanning operation. The printer 211 has a function of printing the image on the printing medium. The printer 211 may print the image by an ink jet method or print the image by an electrophotographic method. The device I/F 209 is connected to the scanner 210 and the printer 211. With this connection configuration, the controller unit 201 can cause the scanner 210 to input the image data. Alternatively, the controller unit 201 can cause the printer 211 to output the image data. That is, with this connection configuration, the controller unit 201 can obtain the image data by the scanning operation of the document and output the image data by printing on the printing medium.

Note that, the PC 102 has a similar hardware configuration to that of the image formation apparatus 101 in FIG. 2 without the scanner 210 and the printer 211, and description of the hardware configuration is omitted. Note that, the PC 102 may have a hardware configuration including the scanner 210 and the printer 211.

### <Software Configuration>

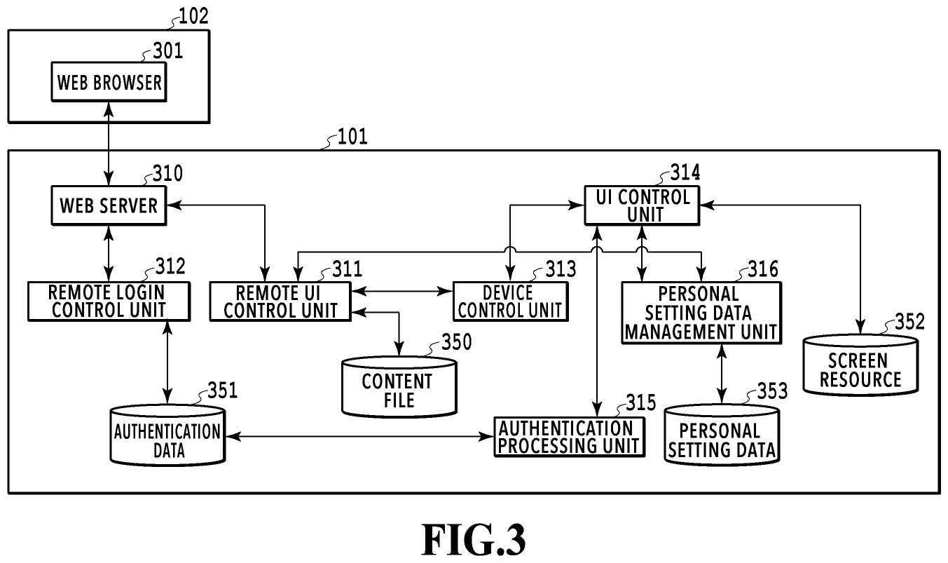

FIG. 3 is a diagram illustrating an example of software configurations of the image formation apparatus 101 and the PC 102. The image formation apparatus 101 includes multiple software modules. The multiple software modules include a web server 310, a remote UI control unit 311, a remote login control unit 312, a device control unit 313, a UI control unit 314, an authentication processing unit 315, and a personal setting data management unit 316. Additionally, data used by the multiple software modules includes a content file 350, authentication data 351, a screen resource 352, and personal setting data 353.

Each software module and data are stored in the ROM 204 or the HDD 205. Each software module is deployed from the ROM 204 or the HDD 205 to the RAM 203 as needed in the execution by the CPU 202. The content file 350, the authentication data 351, the screen resource 352, and the personal setting data 353 may be stored in the ROM 204 or may be stored in the HDD 205.

### <HTTP Request>

The PC 102 includes a web browser 301. The web browser 301 is a general browser application. The web browser 301 establishes communication conforming to the HTTP protocol with the web server 310 in the image formation apparatus 101. In the communication conforming to the HTTP protocol, the HTTP request is transmitted in a case of requesting from the web browser 301 to the web server 310. The HTTP request is formed of the request row, a header field, and a body. The request row is formed of a method, the URI, and HTTP version information. The method is a type of a processing command. The method may include, for example, “GET” to request the resource, “POST” to transmit the resource, and the like. In this case, the resource is a file specified by the URI of the request row.

Multiple elements are defined in the header field. Each element is formed of a pair of a field name and contents of the field name. The multiple elements include, for example, “Accept-Language”, “User-Agent”, and the like. In the body, a parameter used for the method is defined. In the web browser 301, the user can set prioritized language information to the element of the header field as request setting information. In this case, the prioritized language information is information of multiple natural languages that can be used in the web browser 301 and that is information to which priorities are set. The prioritized language information set to the web browser 301 is transmitted as an “Accept-Language header” included in the header of the HTTP request in a case where the web browser 301 transmits the HTTP request to the web server. For example, according to a request for comments (RFC) 7231, the contents of the “Accept-Language header” can be specified as below.

Accept-Language: ja, en-US;q=0.8, en;q=0.7

The semantics of the syntax described above is “Japanese is preferable, American English is also accepted, and another kind of English may be accepted”. The weighting of priority is specified by using a parameter q. The language with the highest priority is that without the parameter q. In a case where there is the parameter q, the greater the number, the higher the priority. Note that, as the prioritized language information of the web browser 301, the language of the OS of the PC 102 or the web browser 301 is usually set by default. Accordingly, usually, the proper setting is set without the user of the PC 102 consciously setting the prioritized language information of the web browser 301. For example, in a case where the user of the PC 102 is a Japanese, it is considered that the OS and the web browser 301 of Japanese version are operating, and the language set as the prioritized language information of the web browser 301 is being set to Japanese as well. In this case, “Accept-Language: ja” is included in the header field of the HTTP request transmitted to the web browser 301.

### <HTTP Response>

The web server 310 establishes communication conforming to the HTTP protocol with the web browser 301 in the PC 102. Specifically, the web server 310 receives the HTTP request from the web browser 301. According to the HTTP request, the web server 310 calls the software module as needed. The web server 310 returns the HTTP response based on the called software module to the web browser 301. The HTTP response is formed of a status row, a header field, and the body. The status row is formed of three-digit number. This three-digit number notifies the client of a result of the HTTP request. For example, in a case of numbers in 200 s, notified contents are “success”. The “success” indicates that the HTTP request succeeds. For example, in a case where the method is “PUT”, the resource indicating a result of the operation is transmitted by the message body. As with the HTTP request, in the header field, each element is formed of a pair of the field name and contents of the field name. The body includes response contents from the server to the HTTP request.

### <Authentication Processing in Remote Login Control Unit 312>

In a case where the first HTTP request is received from the web browser 301, the web server 310 calls the remote login control unit 312 from the multiple software modules. The web server 310 causes the remote login control unit 312 to execute login processing (also referred to as authentication processing). The remote login control unit 312 performs the authentication processing based on information of the authentication data 351. Specifically, once the remote login control unit 312 is called by the web server 310, the remote login control unit 312 generates data of a screen to request input of an ID and a password for authentication. The remote login control unit 312 transmits the generated screen to the web browser 301 to display the screen. In a case where input by the user is performed on the screen that is displayed on the web browser 301 and requests input of the ID and the password for authentication, the remote login control unit 312 receives the inputted ID and password for authentication via the web server 310. The remote login control unit 312 checks the received ID and password for authentication against the authentication data 351 to perform the authentication processing.

### <Authentication Succeeds>

In a case where authentication succeeds, the remote login control unit 312 calls the remote UI control unit 311 and executes requested processing based on the HTTP request. Once the remote UI control unit 311 receives the request of the HTTP request, the remote UI control unit 311 calls the device control unit 313 based on the contents of the request. The device control unit 313 can operate the scanner 210 or the printer 211 in FIG. 2 via the device I/F 209 in FIG. 2. In a case where the scanner 210 is operated, the device control unit 313 can copy the document or scan the document. In a case where the printer 211 is operated, the device control unit 313 can copy the document or perform printing on the printing medium. Additionally, the remote UI control unit 311 reads out various files stored in the content file 350 (a template file, an image file, a script, a script file, and so on). The remote UI control unit 311 generates the HTTP response with reference to the various files read out. The remote UI control unit 311 returns the generated HTTP response to the web browser 301 by way of the web server 310. Note that, in a case of generating the HTTP response, the Accept-Language header is referenced. The Accept-Language header is included in the HTTP request obtained from the web browser 301.

### <Authentication Fails>

On the other hand, in a case where authentication fails, the remote login control unit 312 generates a screen to notify of an authentication error and causes the web browser 301 to display an authentication fail screen via the web server 310.

### <Authentication Processing in UI Control Unit 314>

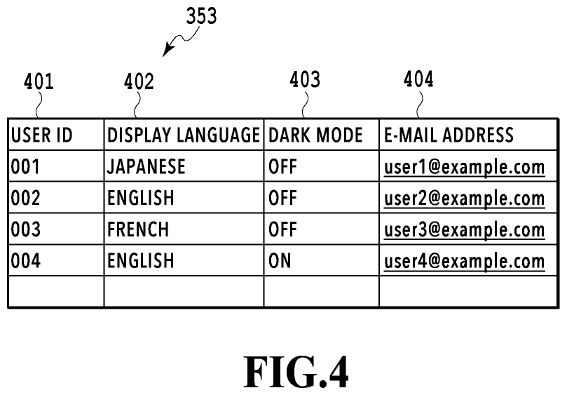

The UI control unit 314 performs control processing of input and output to and from the display and operation unit 207 of the image formation apparatus 101. Specifically, the UI control unit 314 receives information of the operation performed by the user by using the hard key and the touch panel of the display and operation unit 207 via the display and operation unit I/F 206. The UI control unit 314 generates an operation screen based on the operation information received from the display and operation unit 207 or information notified from the device control unit 313, the authentication processing unit 315, and the like. The UI control unit 314 causes the display and operation unit 207 to display the generated operation screen via the display and operation unit I/F 206. Specifically, the UI control unit 314 reads out the resource of the screen from the screen resource 352 as needed and generates the screen by arranging the resource of the screen read out. In this process, the UI control unit 314 obtains the ID of the user who logs in from the authentication processing unit 315 and reads out personal setting of the user from the personal setting data 353 by way of the personal setting data management unit 316. The UI control unit 314 generates a screen based on the personal setting data 353. For example, the UI control unit 314 generates a screen based on display language setting 402 of the user who logs in that is described later with reference to FIG. 4. In a case where the language set by the display language setting 402 of the user who logs in is Japanese, the UI control unit 314 generates the screen in Japanese. Alternatively, in a case where the language set by the display language setting 402 of the user who logs in is English, the UI control unit 314 generates the screen in English. Alternatively, for example, in a case where dark mode setting 403 of the user who logs in that is described later with reference to FIG. 4 is set to OFF, the UI control unit 314 generates a white-based screen. In a case where the dark mode setting 403 of the user who logs in is set to ON, the UI control unit 314 generates a black-based screen. Note that, it is possible to display the operation screen generated by the UI control unit 314 on the web browser 301 of the PC 102 by the remote UI function of the image formation apparatus 101. In addition, the operation screen generated by the UI control unit 314 can also be operated by the user via the web browser 301 of the PC 102.

The authentication processing unit 315 is called by the UI control unit 314 in executing the authentication processing and performs the authentication processing. Specifically, in a case of being called by the UI control unit 314, information of the ID and the password for authentication is provided. The authentication processing unit 315 checks the provided information of the ID and the password against the information of the authentication data 351 to perform the authentication processing and returns the authentication result to the UI control unit 314. The UI control unit 314 generates the screen based on the authentication result. Note that, the information of the ID and the password for authentication may be inputted by the user using at least either of the hard key and the touch panel of the display and operation unit 207 or may be obtained from an IC card and the like.

### <Personal Setting Management>

The personal setting data management unit 316 manages the personal setting data 353 of the user who uses the image formation apparatus 101. The personal setting data management unit 316 is called by either of the UI control unit 314 and the remote UI control unit 311. In a case where the personal setting data management unit 316 is called by the UI control unit 314, the personal setting data management unit 316 associates the personal setting data with the user ID by an instruction from the UI control unit 314. The personal setting data management unit 316 stores the personal setting data associated with the user ID as one of personal setting element data forming the personal setting data 353. With this operation, the personal setting data management unit 316 can return the personal setting data associated with the user ID by the instruction from the UI control unit 314 or an instruction from the remote UI control unit 311.

### <Personal Setting Data 353>

FIG. 4 is a diagram schematically illustrating an example of a configuration of the personal setting data 353. The personal setting data 353 is setting information that can be held for each user out of the various types of setting of the image formation apparatus 101. The personal setting data 353 is formed of setting information of each of the display language setting 402, the dark mode setting 403, and e-mail address setting 404 for each user ID 401. That is, the personal setting data 353 includes the setting information of each of the display language setting 402, the dark mode setting 403, and the e-mail address setting 404 in a unit of the user ID 401 so as to be able to search with the user ID 401. The user ID 401 is an identifier that can uniquely specify the user. The display language setting 402 is setting information indicating the display language of the screen to be displayed on the display and operation unit 207. The dark mode setting 403 is setting information to specify whether to generate the black-based screen (a dark mode) or the white-based screen (a light mode) in a case of generating the screen to be displayed on the display and operation unit 207. The e-mail address setting 404 is setting information of an e-mail address of each user.

For example, in FIG. 4, an example in which “001” is included as the user ID 401, “Japanese” is included as the display language setting 402, “OFF” is included as the dark mode setting 403, and “user1@example.com” is included as the e-mail address setting 404, respectively, is illustrated. In this case, the display language setting 402 that is “Japanese”, the dark mode setting 403 that is “OFF”, the e-mail address setting 404 that is “user1@example.com” are each associated with the user ID 401 that is “001”. Additionally, for example, an example in which “002” is included as the user ID 401, “English” is included as the display language setting 402, “OFF” is included as the dark mode setting 403, and “user2@example.com” is included as the e-mail address setting 404, respectively, is illustrated. In this case, the display language setting 402 that is “English”, the dark mode setting 403 that is “OFF”, and the e-mail address setting 404 that is “user2@example.com” are each associated with the user ID 401 that is “002”. Moreover, for example, an example in which “003” is included as the user ID 401, “French” is included as the display language setting 402, “OFF” is included as the dark mode setting 403, and “user3@example.com” is included as the e-mail address setting 404, respectively, is illustrated. In this case, the display language setting 402 that is “French”, the dark mode setting 403 that is “OFF”, the e-mail address setting 404 that is “user3@example.com” are each associated with the user ID 401 that is “003”. Furthermore, for example, an example in which “004” is included as the user ID 401, “English” is included as the display language setting 402, “ON” is included as the dark mode setting 403, and “user4@example.com” is included as the e-mail address setting 404, respectively, is illustrated. In this case, the display language setting 402 that is “English”, the dark mode setting 403 that is “ON”, and the e-mail address setting 404 that is “user4@example.com” are each associated with the user ID 401 that is “004”.

Note that, the personal setting data 353 illustrated in FIG. 4 is an example, and other information may be included. For example, information indicating a phone number of each user may be added or replaced with another element. Additionally, instead of the display language setting, information specifying national origin of the user may be included in the personal setting data 353. In this case, language-used-in-national-origin setting that can specify the language used in the national origin based on the national origin of the user may be provided, and the language information set by the language-used-in-national-origin setting may be referenced from the personal setting data 353.

### <Operation Example>

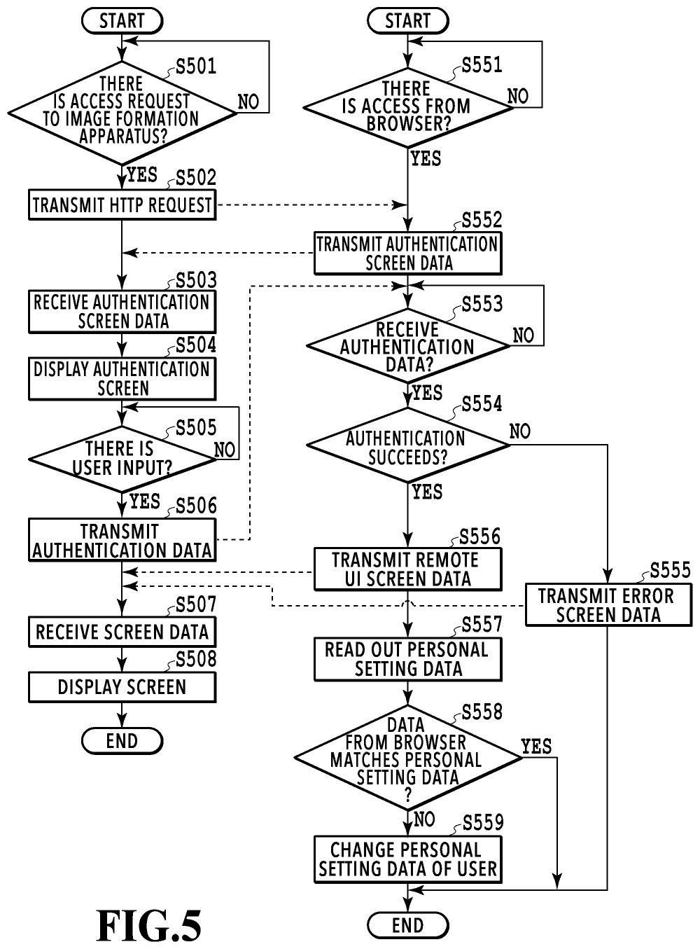

FIG. 5 is a flowchart describing cooperation processing between the web browser 301 and the image formation apparatus 101. In FIG. 5, a scenario in a case where the user accesses the image formation apparatus 101 from the web browser 301 of the PC 102 is assumed. That is, it is assumed that the operation screen generated by the UI control unit 314 is displayed on the web browser 301 of the PC 102 by the remote UI function of the image formation apparatus 101, and the user performs the operation via the web browser 301 of the PC 102. Additionally, a part of or all the functions in steps in FIG. 5 may be implemented by hardware such as an ASIC or an electronic circuit. A sign “S” in each description of the processing means that it is a step in the flowchart. Moreover, processing from S501 to S508 in the flowchart in FIG. 5 is implemented with a CPU of the PC 102 deploying a program for implementing each software module stored in a ROM or an HDD to a RAM to execute. Specifically, the processing from S501 to S508 is processing executed by the web browser 301 executed by the CPU of the PC 102, and the web browser 301 starts the processing from S501. On the other hand, processing from S551 to S559 in the flowchart in FIG. 5 is implemented with the CPU 202 deploying the program for implementing each software module stored in the ROM 204 or the HDD 205 to the RAM 203 to execute. Specifically, the processing from S551 to S559 is processing executed by the CPU 202 of the image formation apparatus 101, and the CPU 202 starts the processing from S551. Note that, an arrow indicated by a dotted line in FIG. 5 indicates a flow of information transmitted and received between the image formation apparatus 101 and the PC 102.

The flowchart in FIG. 5 is started based on that the operation of the remote UI is started from the web browser 301 of the PC 102 for the image formation apparatus 101 after the communication between the image formation apparatus 101 and the PC 102 is established.

### <PC 102: Access Request>

In S501, the CPU of the PC 102 determines whether there is an access request to the image formation apparatus 101. If it is determined that there is the access request to the image formation apparatus 101, the CPU of the PC 102 allows the processing to proceed to S502. In S502, the CPU of the PC 102 transmits the HTTP request to the image formation apparatus 101, and the processing proceeds to S503. On the other hand, if it is determined that there is no access request to the image formation apparatus 101, the CPU of the PC 102 continues the processing in S501.

### <Access Request: First Case Example; Second Case Example>

Specifically, the access request may include the following first case example or second case example. As the first case example, a uniform resource locator (URL) of the image formation apparatus 101 may be inputted to an address entry field of the web browser 301. In this first case example, the web browser 301 determines that there is the access request to the image formation apparatus 101. Alternatively, as the second case example, the link of the URL of the image formation apparatus 101 may be clicked. In this second case example, the web browser 301 also determines that there is the access request to the image formation apparatus 101. Like the above-described two case examples, if the web browser 301 determines that there is the access request to the image formation apparatus 101, the web browser 301 allows the processing to proceed from S501 to the processing in S502. In S502, the web browser 301 transmits the HTTP request designating the inputted URL to the image formation apparatus 101. Note that, the HTTP request includes the Accept-Language header. More specifically, the inputted URL is included in the request row forming the HTTP request. Additionally, the Accept-Language header may include the language information corresponding to the display language of the web browser 301 as the prioritized language information.

### <Image Formation Apparatus 101: Authentication Screen Data Transmission>

In S551, the CPU 202 of the image formation apparatus 101 determines whether there is the access from the web browser 301. If it is determined that there is the access from the web browser 301, the CPU 202 of the image formation apparatus 101 allows the processing to proceed to S552. In S552, the CPU 202 of the image formation apparatus 101 transmits authentication screen data. On the other hand, if it is determined that there is no access from the web browser 301, the CPU 202 of the image formation apparatus 101 continues the processing in S551. Specifically, if the web server 310 receives the HTTP request transmitted by the web browser 301 in S502, the processing proceeds to S552. In S552, the CPU 202 of the image formation apparatus 101 transmits the authentication screen data to the web browser 30. More specifically, the web server 310 calls the remote login control unit 312. The remote login control unit 312 generates the authentication screen data. The web server 310 transmits the authentication screen data to the web browser 301.

### <PC 102: Operation of Authentication Screen>

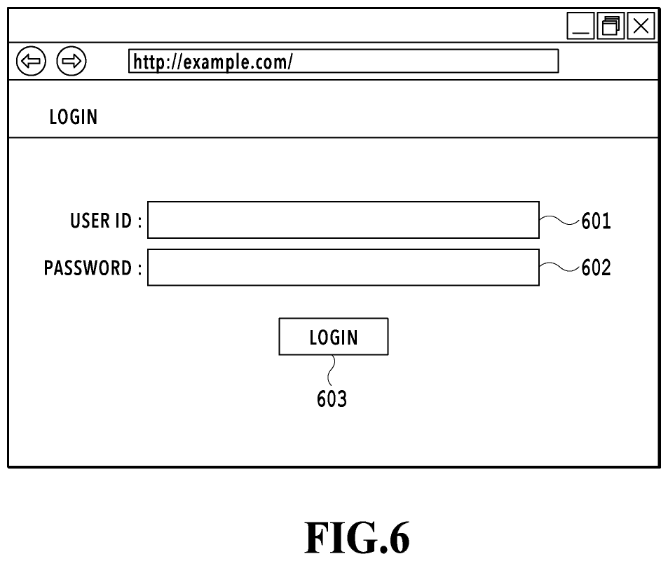

In S503, the CPU of the PC 102 receives the authentication screen data, and the processing proceeds to S504. In S504, the CPU of the PC 102 displays the authentication screen, and the processing proceeds to S505. In S505, the CPU of the PC 102 determines whether there is the user input. If it is determined that there is the user input, the CPU of the PC 102 allows the processing to proceed to S506. In S506, the CPU of the PC 102 transmits the authentication data. On the other hand, if it is determined that there is no user input, the CPU of the PC 102 continues the processing in S505. Specifically, in S503, the web browser 301 receives the authentication screen data transmitted from the image formation apparatus 101 in S552. In S504, the web browser 301 displays the authentication screen based on the received authentication screen data. More specifically, FIG. 6 is a diagram illustrating an example of the authentication screen displayed by the web browser 301. The authentication screen includes a user ID entry field 601, a password entry field 602, and a login button 603. In S505, the web browser 301 determines whether there is input to each of the user ID entry field 601 and the password entry field 602 as the user input and whether the login button 603 is operated. If it is determined that there is the user input, the processing proceeds to S506. In S506, the web browser 301 transmits the user ID and the password inputted to the user ID entry field 601 and the password entry field 602, respectively, to the image formation apparatus 101 as the authentication data. Note that, in a case like S502, S506, and the like where various data are transmitted from the web browser 301 to the image formation apparatus 101, the Accept-Language header is applied. That is, the transmission from the web browser 301 to the image formation apparatus 101 like S502, S506, and the like is implemented by transmission of the HTTP request.

### <Image Formation Apparatus 101: User Authentication>

In S553, the CPU 202 of the image formation apparatus 101 determines whether the authentication data is received. If it is determined that the authentication data is received, the CPU 202 of the image formation apparatus 101 allows the processing to proceed to S554. On the other hand, if it is determined that the authentication data is not received, the CPU 202 of the image formation apparatus 101 continues the processing in S553. That is, the CPU 202 of the image formation apparatus 101 waits for the reception of the authentication data. In S554, the CPU 202 of the image formation apparatus 101 determines whether the authentication succeeds. If it is determined that the authentication succeeds, the CPU 202 of the image formation apparatus 101 allows the processing to proceed to S556. On the other hand, if it is determined that the authentication does not succeed, the CPU 202 of the image formation apparatus 101 allows the processing to proceed to S555. In S555, the CPU 202 of the image formation apparatus 101 transmits error screen data and ends the processing. In S556, the CPU 202 of the image formation apparatus 101 transmits remote UI screen data, and the processing proceeds to S557.

Specifically, in S553, if the web server 310 receives the authentication data transmitted from the web browser 301, the processing proceeds to S554. In receiving this authentication data, the Accept-Language header included in the HTTP request is also received. The reason is to generate screen data in the language designated by the Accept-Language header notified from the web browser 301 in a case of transmitting the HTTP response to the web browser 301. In S554, the web server 310 calls the remote login control unit 312. The authentication data received by the web server 310 is provided to the remote login control unit 312. The remote login control unit 312 checks user input information that is the provided authentication data against the authentication information of the authentication data 351. The remote login control unit 312 returns the checked authentication result to the web server 310. If it is the authentication result indicating that the authentication does not succeed, the processing proceeds to S555. On the other hand, if it is the authentication result indicating that the authentication succeeds, the processing proceeds to S556. In this case, the unsuccess of the authentication means that the user input information does not match the authentication information of the authentication data 351; however, it is not limited thereto. For example, the unsuccess of the authentication may include also a case where the user input information is broken and cannot be checked.

### <Case Where Authentication Does Not Succeed: Error Screen Transmission>

In S555, the remote login control unit 312 generates a screen to notify of the authentication error and transmits the generated error screen data to the web browser 301. The generated error screen data is generated in the language designated by the Accept-Language header notified from the web browser 301.

### <Case Where Authentication Succeeds: Remote UI Screen Transmission>

In S556, the remote login control unit 312 returns the fact that the authentication succeeds to the web server 310. Once the web server 310 receives the response about the success of the authentication from the remote login control unit 312, the web server 310 calls the remote UI control unit 311. The called remote UI control unit 311 generates the remote UI screen data by reading out the content file 350 and transmits the generated remote UI screen data to the web browser 301. The generated remote UI screen data is generated in the language designated by the Accept-Language header notified from the web browser 301.

### <PC 102: Screen Display (Overview)>

In S507, the PC 102 receives the screen data from the web server 310. The screen data received by the web browser 301 of the PC 102 from the web server 310 is the error screen data in S555 or the remote UI screen data in S556. In S508, the PC 102 displays the screen based on the received screen data and ends the series of the processing.

### <PC 102: Screen Display (Error Screen)>

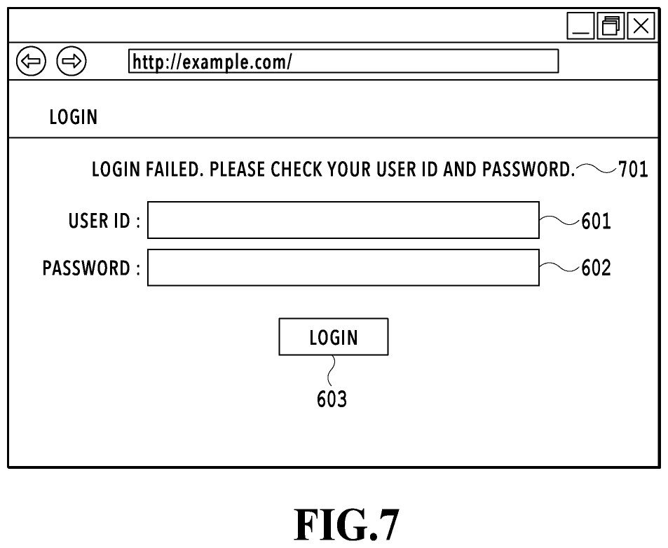

FIG. 7 is a diagram illustrating an example of the authentication error screen displayed by the web browser 301. In an example in FIG. 7, in addition to the display of the user ID entry field 601, the password entry field 602, and the login button 603 in FIG. 6, display of a message 701 is added above the user ID entry field 601. The message 701 includes contents notifying of the unsuccess of the authentication. For example, as the message 701, a text “Login failed. Please check your user ID and password.” is displayed on the web browser 301. Note that, the text of the message 701 is not limited thereto. For example, a text such as “Cannot read your user ID and password. Please input again.” may be applied. Alternatively, a text such as “Inputted user ID is not registered. Please input again.” may be applied. Alternatively, a text such as “Incorrect password.” may be applied. In short, the contents of the message 701 may be anything as long as it can indicate that there is the authentication error.

### <PC 102: Screen Display (Remote UI Screen)>

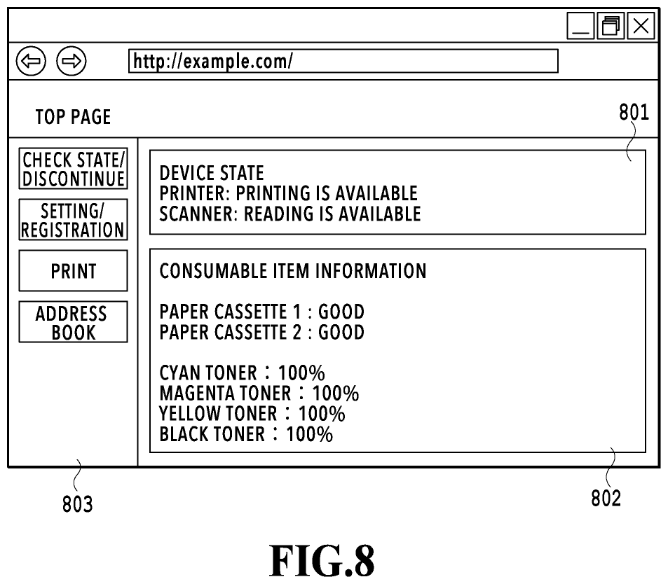

FIG. 8 is a diagram illustrating an example of the remote UI screen displayed by the web browser 301. In an example in FIG. 8, the remote UI screen is formed of regions 801 to 803. In the region 801, states of the printer 211 and scanner 210 are indicated. In FIG. 8, a text “printing is available” is displayed as the state of the printer 211. Additionally, in FIG. 8, a text “reading is available” is displayed as the state of the scanner 210. In the region 802, consumable item information is displayed. In FIG. 8, a storage state of the printing medium in each paper cassette and each color toner remaining amount are displayed as the consumable item information. In the region 803, a link button is displayed. In FIG. 8, for example, a button to call a function of checking the states of the printer 211 or the scanner 210 or discontinuing use is displayed as the link button. As the link button, in addition, for example, a button to call a function of performing setting or registration of the printer 211 or the scanner 210, a button to call a function of performing printing, and a button to call an address book are displayed. Note that, as the link button, it is not limited to the above.

### <Image Formation Apparatus 101: Personal Setting Data Determination>

In S557, the CPU 202 of the image formation apparatus 101 reads out the personal setting data. Specifically, the CPU 202 of the image formation apparatus 101 notifies the personal setting data management unit 316 of the authentication data received from the web browser 301. The personal setting data management unit 316 reads out the personal setting information of the user. In S558, the CPU 202 of the image formation apparatus 101 determines whether the data from the web browser 301 matches the personal setting data. In this case, the data from the web browser 301 as a comparison target with the personal setting data is the Accept-Language header. That is, in S558, the CPU 202 of the image formation apparatus 101 determines whether the language specified as the prioritized language information matches the language specified as the display language setting 402 in FIG. 4. If it is determined that the data from the web browser 301 matches the personal setting data, the CPU 202 of the image formation apparatus 101 ends the processing. If it is determined that the data from the web browser 301 does not match the personal setting data, the CPU 202 of the image formation apparatus 101 allows the processing to proceed to S559. In S559, the CPU 202 of the image formation apparatus 101 changes the personal setting data of the user and ends the processing. Specifically, in S559, the remote UI control unit 311 notifies the personal setting data management unit 316 of the user ID and the prioritized language information included in the Accept-Language header. The personal setting data management unit 316 rewrites the display language setting 402 of the personal setting data 353 of the user corresponding to the received user ID to the prioritized language information received by the Accept-Language header.

### <Login Screen of Image Formation Apparatus 101>

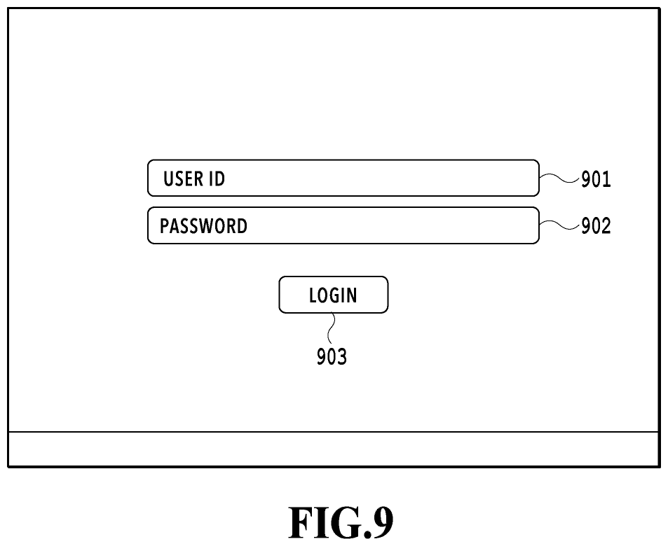

FIG. 9 is a diagram illustrating an example of the login screen displayed on the display and operation unit 207. In FIG. 9, an example in which the image formation apparatus 101 is operated by the user authentication is illustrated. That is, power is applied to the image formation apparatus 101 to perform initializing processing and the like, and once the image formation apparatus 101 is activated, the login screen in FIG. 9 is displayed. In the example in FIG. 9, a user ID entry field 901, a password entry field 902, and a login button 903 are each displayed. For example, in a case where a part of the user ID entry field 901 is pressed by the user, a soft keyboard screen (not illustrated) is called, and thus the user can input the user ID by using the displayed soft keyboard. In the password entry field 902, it is also possible to perform input by a similar operation as that in the user ID entry field 901. The login button 903 is operated by the user after the input to the user ID entry field 901 and the password entry field 902 to execute the authentication processing. The authentication processing is executed by the authentication processing unit 315. The authentication processing unit 315 can check the user ID and password inputted to the user ID entry field 901 and the password entry field 902, respectively, against the authentication data 351. Note that, instead of the input of the user ID and the password, an IC card and the like may be used or biometric authentication may be performed. In a case where the user authentication succeeds, the UI control unit 314 generates an operation screen such as a home screen and causes the display and operation unit 207 to display the screen. In generating the operation screen, the UI control unit 314 provides the user ID of the user who logs in to the personal setting data management unit 316, reads out the display language setting 402 of the user, and generates the operation screen in the set language.

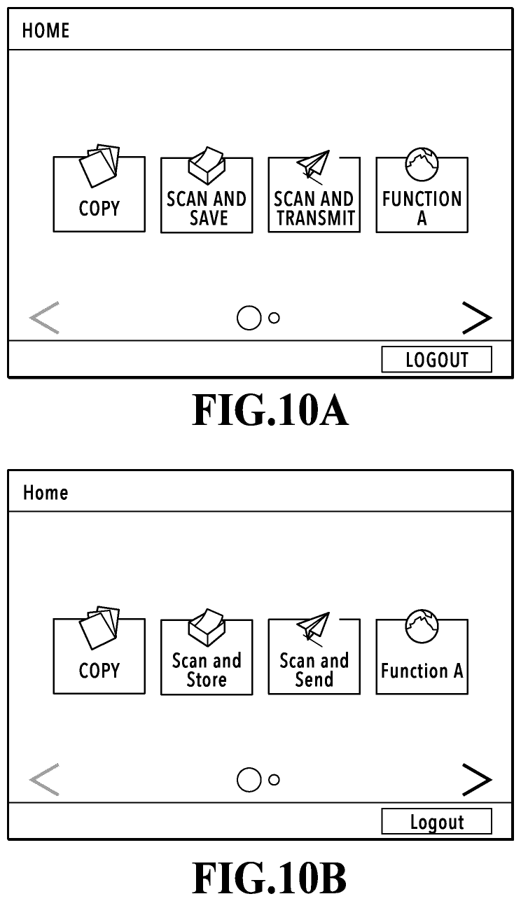

FIGS. 10A and 10B are diagrams illustrating an example of the home screen displayed on the display and operation unit 207. FIG. 10A is a diagram illustrating an example of the home screen displayed in a case where the user corresponding to the language “Japanese” set by the display language setting 402 logs in. The user in FIG. 10A is, for example, the user of the user ID “001” in FIG. 4. FIG. 10B is a diagram illustrating an example of the home screen displayed in a case where the user corresponding to the language “English” set by the display language setting 402 logs in. The user in FIG. 10B is, for example, the user of the user ID “002” in FIG. 4.

### <Effect of First Embodiment>

As described above, in a case of the access from the web browser 301 to the image formation apparatus 101, according to the information of the Accept-Language header transmitted from the web browser 301, the display language setting 402 of the personal setting data 353 of the user is changed. Additionally, the screen displayed on the display and operation unit 207 in a case where the user logs in from the operation panel of the image formation apparatus 101 is the screen according to the display language setting 402 set to the personal setting data 353. As described above, the information of the Accept-Language header transmitted from the web browser 301 is usually in proper setting without conscious setting by the user. Accordingly, it is possible to achieve the following by changing the display language setting 402 of the personal setting data 353 of the user according to the information of the Accept-Language header. That is, it is possible to allow the user to use the image formation apparatus 101 in the proper display language only by accessing once the image formation apparatus 101 from the web browser 301 that the user usually uses. Therefore, it is possible to improve the convenience for the user.

Note that, although an example in which the display language setting 402 of the personal setting data 353 of the user is changed according to the information of the Accept-Language header transmitted from the web browser 301 is described in the above descriptions, it is not limited thereto. For example, in a case where the dark mode setting 403 in FIG. 4 is available as the setting of the web browser 301, the present embodiment may be applied to the dark mode setting 403. In this case, in a case of access from the web browser 301 to the web server 310, setting information of the dark mode setting 403 of the web browser 301 is obtained. Then, in S557, whether the setting information of the dark mode setting 403 of the web browser 301 matches the setting information of the dark mode setting 403 of the user is determined. If they do not match, in S559, the CPU 202 rewrites the dark mode setting 403 of the user. Thus, the screen displayed on the display and operation unit 207 in a case where the user logs in from the operation panel of the image formation apparatus 101 matches the setting information of the dark mode setting 403 of the web browser 301. Accordingly, it is possible to allow the user to use the image formation apparatus 101 with the proper screen.

### Second Embodiment

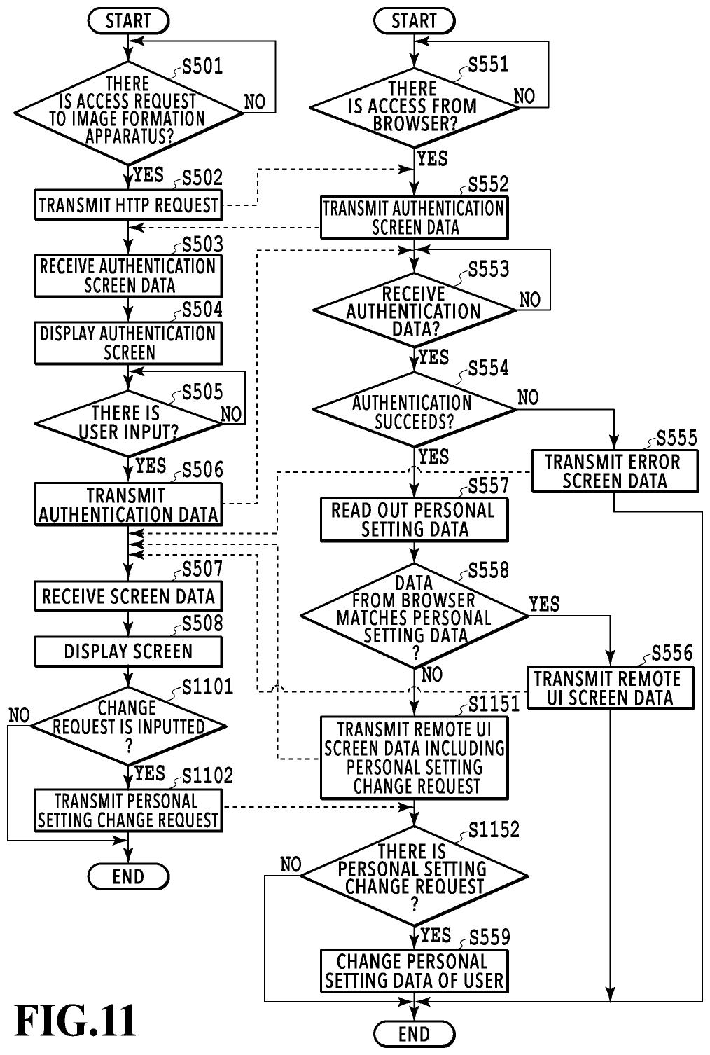

In a second embodiment, description of a configuration similar to that in the first embodiment is omitted. In the first embodiment, the personal setting of the user is automatically changed according to the setting transmitted from the web browser 301. The second embodiment is different from the first embodiment in that the user can select whether to change the personal setting on a remote UI side. Specifically, a selection screen (notification) on which whether to change the personal setting can be selected is displayed. FIG. 11 is a flowchart describing cooperation processing between the web browser 301 and the image formation apparatus 101.

### <Operation Example>

### <Image Formation Apparatus 101: User Authentication>

Since the processing until S554 is similar to the processing in FIG. 5, description thereof is omitted. In S554, if it is determined that the authentication succeeds, the CPU 202 of the image formation apparatus 101 allows the processing to proceed to S557. The processing in S557 is similar to the processing in FIG. 5.

### <Image Formation Apparatus 101: Personal Setting Data Determination>

In S558, the CPU 202 of the image formation apparatus 101 determines whether the data from the web browser 301 matches the personal setting data. If it is determined that the data from the web browser 301 matches the personal setting data, the CPU 202 of the image formation apparatus 101 allows the processing to proceed to S556. The processing in S556 is similar to the processing described in FIG. 5, and after the processing in S556, the processing ends. On the other hand, if it is determined that the data from the web browser 301 does not match the personal setting data, the CPU 202 of the image formation apparatus 101 allows the processing to proceed to S1151. In S1151, the CPU 202 of the image formation apparatus 101 transmits the remote UI screen data including personal setting change confirmation. Specifically, the remote UI screen data obtained by adding a UI element to allow the user to select whether to change the personal setting to the remote UI screen generated in S556 is transmitted to the web browser 301.

### <PC 102: Screen Display (Overview)>

In S507, the PC 102 receives the screen data from the web server 310. The screen data that the web browser 301 of the PC 102 receives from the web server 310 is the error screen data in S555, the remote UI screen data in S556, or the remote UI screen data in S1151. In S508, the PC 102 displays the screen based on the received screen data.

### <PC 102: Screen Display (Remote UI Screen+Change Confirmation Region 1201)>

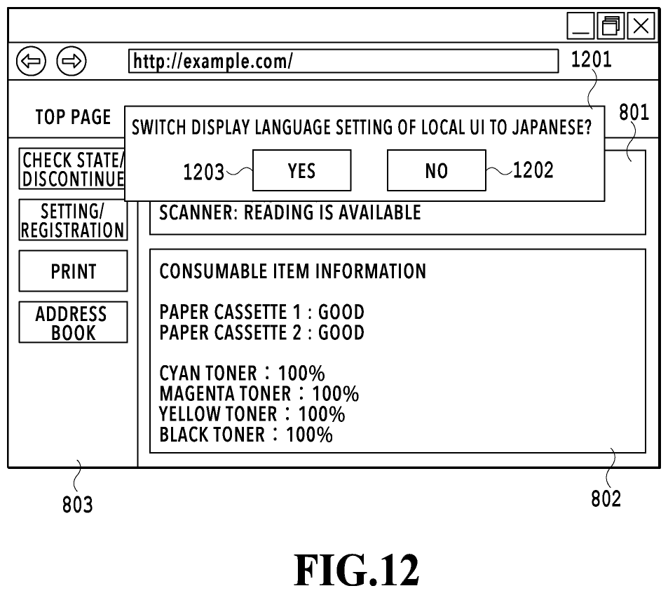

FIG. 12 is a diagram illustrating an example of the remote UI screen displayed by the web browser 301. The remote UI screen in FIG. 12 is the remote UI screen in S1151. Therefore, the remote UI screen in FIG. 12 includes contents indicating the personal setting change confirmation. In the example in FIG. 12, a change confirmation region 1201 is added as the contents indicating the personal setting change confirmation, and thus a state in which a part of the screen in FIG. 8 is hidden by the change confirmation region 1201 is obtained. The change confirmation region 1201 includes a button 1202 and a button 1203. The button 1202 indicates “No”. The button 1203 indicates “Yes”. In S1101, if it is determined that a change request is inputted, that is, in a case where the button 1203 is operated, the PC 102 allows the processing to proceed to S1102. In S1102, the PC 102 transmits the personal setting change request. On the other hand, if it is determined that the change request is not inputted, that is, the button 1202 is operated, the PC 102 ends the processing.

### <Image Formation Apparatus 101: Personal Setting Change Request>

In S1152, the CPU 202 of the image formation apparatus 101 determines whether there is the personal setting change request. If it is determined that there is the personal setting change request, the CPU 202 of the image formation apparatus 101 allows the processing to proceed to S559. In S559, as with the processing in S559 in FIG. 5, the CPU 202 of the image formation apparatus 101 changes the personal setting data of the user and ends the processing. On the other hand, if it is determined that there is no personal setting change request, the CPU 202 of the image formation apparatus 101 ends the processing.

### <Effect of Second Embodiment>

As described above, in the second embodiment, notification indicating whether to change the personal setting data is displayed. Therefore, it is possible to allow the user to select whether to change the personal setting data on the remote UI side. Accordingly, it is possible to further improve the convenience for the user.

### Third Embodiment

In a third embodiment, description of a configuration similar to that in the first and second embodiments is omitted. The third embodiment is different from the first and second embodiments in that the user can select whether to change the personal setting on a web server 310 side.

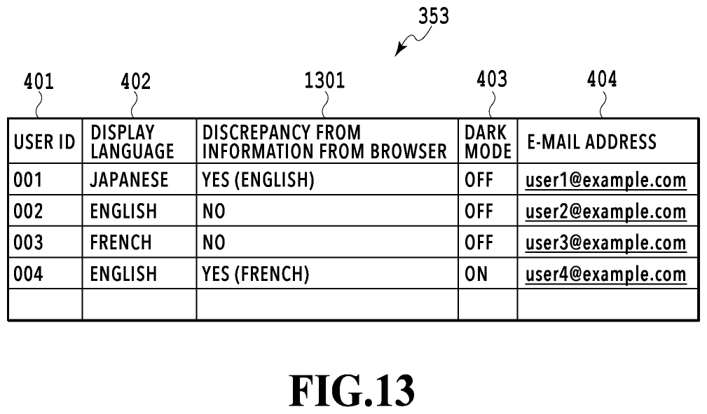

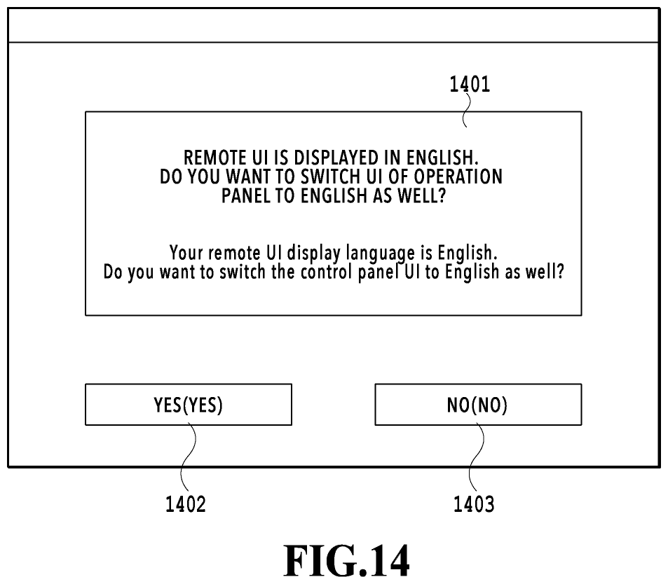

FIG. 13 is a diagram schematically illustrating an example of a configuration of the personal setting data 353. FIG. 13 is different from FIG. 4 in that discrepancy information 1301 indicating whether there is a discrepancy from the information from the web browser is added as new information in addition to the information specifying the various types of setting in FIG. 4. FIG. 14 is a diagram illustrating an example of the home screen displayed on the display and operation unit 207. There is a difference in S559 from the specifying operation in the flowchart in FIG. 5 in the first embodiment. In S559 in FIG. 5 in the first embodiment, the language information specified by the display language setting 402 included in the personal setting data 353 of the user is replaced with the prioritized language information specified in the Accept-Language header. On the other hand, in the third embodiment, the personal setting data 353 includes the information indicating whether there is a discrepancy from the prioritized language information of the web browser 301 and the prioritized language information of the web browser 301.

Specifically, a case where the Accept-Language header in accessing of the user from the web browser 301 is in English although the display language setting 402 of the user of the user ID 001 is Japanese is assumed. Under this assumption, as the discrepancy information 1301 of the user, “yes” is recorded to indicate that there is a discrepancy as illustrated in FIG. 13, for example. Likewise, there is indicated that, although the current display language setting 402 of the user of the user ID 004 is English, the Accept-Language header in accessing from the web browser 301 is not English but French.

FIG. 14 is a diagram illustrating an example of a screen after login that is displayed on the display and operation unit 207. In FIG. 14, a screen example after the user having the user ID 401 of “001” in FIG. 13 logs in. The screen in FIG. 14 includes a message region 1401, a button 1402, and a button 1403. In the message region 1401, a message to confirm whether to set the display language of the screen displayed on the display and operation unit 207 same as the display language in a case of displaying the remote UI is displayed. The display language in a case of displaying the remote UI is the language specified by the prioritized language information specified by the Accept-Language header included in the HTTP request transmitted from the web browser 301. The button 1402 is a button displaying a text “YES”. The button 1403 is a button displaying a text “NO”. In a case where the user operates the button 1402, the setting “Japanese” indicated by the display language setting 402 is changed to the setting “English” specified by the prioritized language information specified by the Accept-Language header. On the other hand, in a case where the user operates the button 1403, the setting “Japanese” indicated by the display language setting 402 is maintained, and the screen in FIG. 14 transitions to the home screen illustrated in FIG. 10A. Note that, the display language in the message region 1401 and the buttons 1402 and 1403 is displayed in both the language of the display language setting 402 and language of the prioritized language information specified by the Accept-Language header. According to this operation, it is possible to facilitate the operation of switching to the proper display language even for the user who has difficulty in understanding in the current display language.

### <Effect of Third Embodiment>

As described above, in the third embodiment, the information based on the display language setting 402 included in the personal setting data 353 and the request setting information included in the HTTP request are both displayed. Therefore, it is possible to facilitate the operation of switching to the proper display language even for the user who has difficulty in understanding in the current display language.

### Fourth Embodiment

In a fourth embodiment, description of a configuration similar to that in the first to third embodiments is omitted. The fourth embodiment is different from the first to third embodiments in that the screen displayed on the display and operation unit 207 of the image formation apparatus 101 is embedded as a part of the screen of the web browser 301.

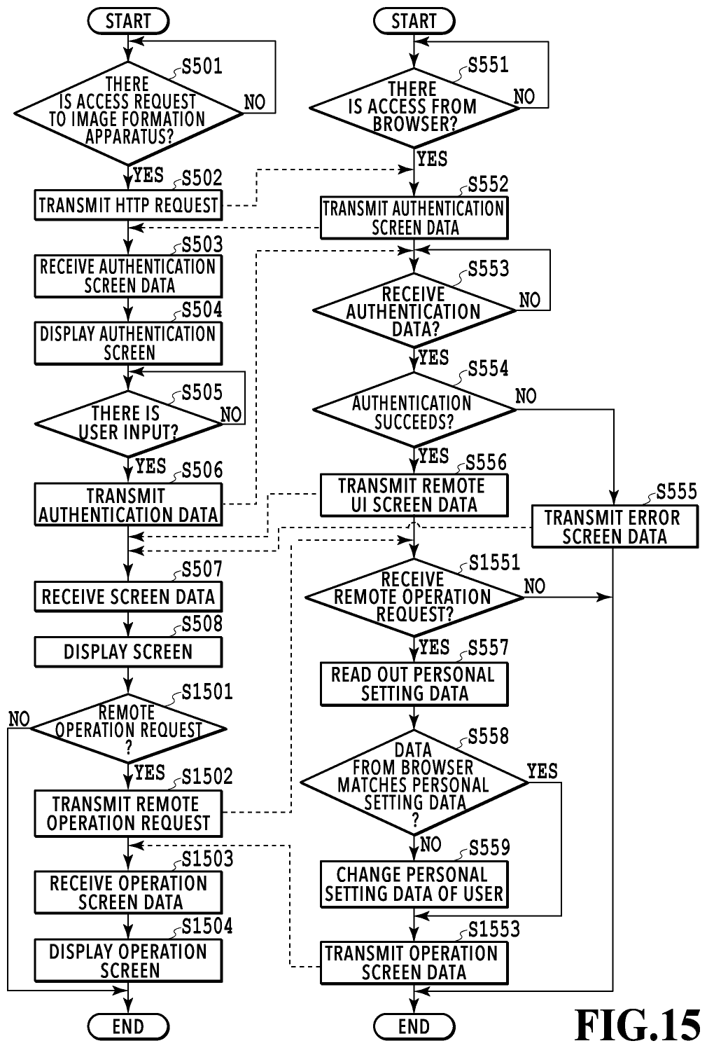

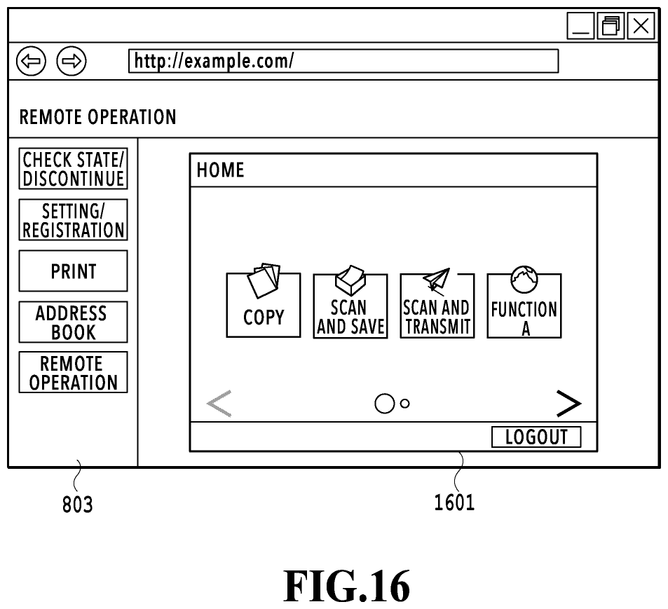

FIG. 15 is a flowchart describing cooperation processing between the web browser 301 and the image formation apparatus 101. FIG. 16 is a diagram illustrating an example of the remote UI screen displayed by the web browser 301. In an operation example of the flowchart in FIG. 15 in the present embodiment, a different point from the operation example in the flowchart in FIG. 5 is described

### <Operation Example>

### <PC 102: Remote Operation Request>

In S1501, the PC 102 determines whether there is a remote operation request. If it is determined that there is the remote operation request, the PC 102 allows the processing to proceed to S1502. For example, with a “remote operation” button in the region 803 in FIG. 16 being operated by the user, it is determined that there is the remote operation request. On the other hand, if it is determined that there is no remote operation request, the processing ends. In S1502, the PC 102 transmits the remote operation request to the web server 310 of the image formation apparatus 101.

### <Image Formation Apparatus 101: Remote Operation Request Reception>

In S1551, the CPU 202 of the image formation apparatus 101 determines whether the remote operation request is received. If it is determined that the remote operation request is received, the CPU 202 of the image formation apparatus 101 allows the processing to proceed to S557, and the processing similar to that in S557 to S559 in FIG. 5 is performed. After the processing in S559, the CPU 202 of the image formation apparatus 101 allows the processing to proceed to S1553. In S1553, the CPU 202 of the image formation apparatus 101 transmits the operation screen data to the web browser 301. Specifically, the remote UI control unit 311 calls the UI control unit 314 and obtains and transmits the data of the screen displayed on the display and operation unit 207.

### <PC 102: Operation Screen>

In S1503, the CPU of the PC 102 receives the operation screen data transmitted in S1553. In S1504, the CPU of the PC 102 causes the web browser 301 to display the screen based on the received operation screen data. FIG. 16 illustrates a screen example by the web browser 301. In a region 1601, a screen that is the same as the operation screen displayed on the display and operation unit 207 of the image formation apparatus 101 is displayed. That is, the screen displayed on the display and operation unit 207 of the image formation apparatus 101 is embedded as a part of the screen of the web browser 301.

### <Effect of Fourth Embodiment>

With the processing in S559, the display language of the personal setting of the user is set to the same as the language specified by the prioritized language information notified by the web browser 301 using the Accept-Language header. Accordingly, the display screen in the region 1601 is a screen in the same language as the language of another region (for example, the region 803) on the remote UI screen. According to this operation, it is possible to provide a screen comfortable for the user.

### Other Embodiments

In the embodiments described above, descriptions are given based on an example in which the configuration connecting the image formation apparatus 101 to the PC 102 is a wired LAN or a wireless LAN. However, it is not limited to this example. The configuration connecting the image formation apparatus 101 to the client terminal may be, for example, Bluetooth (registered trademark) or near field communication (NFC). In a case of a configuration of connection by Bluetooth, for example, it is possible to operate the image formation apparatus 101 even from a place distant from the image formation apparatus 101 in the same room. Alternatively, in a case of a configuration of connection by NFC, for example, it is possible to remotely operate the image formation apparatus 101 by connecting the client terminal like a smartphone even in a case of using the image formation apparatus 101 that does not include the display and operation unit 207.

In the above-described embodiments, descriptions are given based on an example in which the information of the natural language recommended by the HTTP response is included in the Accept-Language. However, it is not limited to this example. The information of the natural language recommended by the HTTP response may be included in a User-Agent header. Alternatively, language information set to the operating system (OS) may be referenced from the information of the OS included in the User-Agent header. That is, what is to be transmitted as the information of the natural language recommended by the HTTP response may be determined based on specifications of the web browser 301.

In the above-described embodiments, descriptions are given based on an example in which each software module is stored in the ROM 204 or the HDD 205 and deployed to the RAM 203 in the execution by the CPU 202. However, it is not limited to this example. For example, a not-illustrated external server may store at least one of the content file 350, the authentication data 351, the screen resource 352, and the personal setting data 353. In this case, the software module may be read from the external server as needed in the execution of the processing by the CPU 202, and the read software module may be deployed to the RAM 203. Additionally, at least one of the remote UI control unit 311, the remote login control unit 312, the device control unit 313, the UI control unit 314, the authentication processing unit 315, and the personal setting data management unit 316 may be stored in the external server. In this case, the web server 310 may execute processing in cooperation with the external server. For example, the authentication processing unit 315 and the authentication data 351 may be stored in the external server. In this case, the web server 310 can execute the authentication processing in cooperation with the external server. With the above cooperation processing, it is also possible to perform processing while distributing a load.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-166795, filed Sep. 28, 2023, which is hereby incorporated by reference wherein in its entirety.

What is claimed is:

1. An information processing apparatus communicable with a client terminal that can use a web browser, comprising:
a memory; and
a processor connected to the memory, wherein
the processor
receives request information including request setting information set to the web browser,
performs authentication processing of a user who uses the information processing apparatus via the web browser in a case where the request information is received by the receiving, and
changes personal setting information associated with the user based on the request setting information in a case where the authentication processing of the user by performing the authentication processing succeeds, and the personal setting information and the request setting information are different from each other.

2. The information processing apparatus according to claim 1, wherein
the request setting information received from the web browser includes setting information indicating prioritized display language.

3. The information processing apparatus according to claim 1, wherein
the request setting information received from the web browser includes setting information of either of a dark mode and a light mode.

4. The information processing apparatus according to claim 1, wherein
the processor notifies of whether to change the personal setting information associated with the user based on the request setting information in a case where the authentication processing of the user by performing the authentication processing succeeds, and the personal setting information and the request setting information are different from each other.

5. The information processing apparatus according to claim 4, wherein
in a case where the processor notifies of whether to change the personal setting information, the processor causes the web browser to display both information based on the request setting information and information based on the personal setting information.

6. The information processing apparatus according to claim 1, wherein
in a case where a request is received to display the same screen on the web browser as a screen displayed on the information processing apparatus, the processor incorporates the screen to be displayed on the information processing apparatus into the screen of the web browser.

7. The information processing apparatus according to claim 1, wherein
the processor additionally
receives an operation by the user and performs displaying based on contents of the operation, and
performs processing of an interface functioning as an interface between the authentication processing of the user and processing of performing displaying based on the contents of the operation, wherein
the authentication processing of the user is formed so as to additionally perform the authentication processing of the user based on information inputted via the processing of the interface, and
the processing of performing displaying based on the contents of the operation is performing the displaying based on the personal setting information associated with the user authenticated via the processing of the interface.

8. The information processing apparatus according to claim 7, wherein
the processing of performing displaying based on the contents of the operation is performing the displaying in a language specified by display language setting included in the personal setting information.

9. The information processing apparatus according to claim 7, wherein
the processing of performing displaying based on the contents of the operation is performing the displaying in a mode specified by mode setting included in the personal setting information.

10. The information processing apparatus according to claim 1, wherein
the request information is information received by communication using an HTTP protocol.

11. A method of controlling an information processing apparatus communicable with a client terminal that can use a web browser, comprising:
receiving request information including request setting information set to the web browser,
performing authentication processing of a user who uses the information processing apparatus via the web browser in a case where the request information is received by the receiving, and
changing personal setting information associated with the user based on the request setting information in a case where the authentication processing of the user by performing the authentication succeeds, and the personal setting information and the request setting information are different from each other.

12. A non-transitory computer readable storage medium that stores a program to cause a computer to execute the steps of:
receiving request information including request setting information set to a web browser,
performing authentication processing of a user who uses an information processing apparatus via the web browser in a case where the request information is received by the receiving, and
changing personal setting information associated with the user based on the request setting information in a case where the authentication processing of the user by performing the authentication succeeds, and the personal setting information and the request setting information are different from each other.
